(19) United States
(12) Patent Application Publication
(10) Pub. No.: US 2007/0234730 A1
(43) Pub. Date: Oct. 11, 2007

(54) Method and apparatus for monitoring combustion instability and other performance deviations in turbine engines and like combustion systems

(76) Inventors: James R. Markham, Middlefield, CT (US); David F. Marran, Durham, CT (US); James J. Scire JR., Vernon, CT (US)

Correspondence Address: IRA S. DORMAN, 330 ROBERTS STREET, SUITE 200, EAST HARTFORD, CT, 06108, US

(21) Appl. No.: 11/248,448

(22) Filed: Oct. 12, 2005

Related U.S. Application Data
(63) Continuation-in-part of application No. 10/606,566, filed on Jun. 26, 2003, now abandoned.
(60) Provisional application No. 60/392,998, filed on Jun. 28, 2002.

(51) Int. Cl. G01N 21/61; F23N 5/14

(52) U.S. Cl. 60/772; 431/13

(57) ABSTRACT

The sensor arrangement, performance-monitored machine system, and method, utilize radiance of exhaust streams to indicate performance deviation, due to combustion instability or machine malfunction, in propulsion gas turbine engines, augmentors used on such engines, stationary power generating gas turbine engines, and other air-breathing combustion-based turbine machines and systems. Sensor operation is based upon high-speed measurements of radiant emission from the hot exhaust stream, taken at a minimum rate of 2000, and preferably at a rate of at least 8000, samples per second. Select infrared wavelengths of light are used to capture temporal variations in the radiance, which are Fourier analyzed to determine the magnitude and frequency of the combustion instability. The apparatus and method enable detection of incipient combustion instability, combustion system health, power loss, stall, surge, and fuel light-off; information and feedback are available for combustion control, to provide an early warning and diagnosis of a physical and/or mechanical malfunction, and to indicate a need for condition-based maintenance.

### CROSS REFERENCE TO RELATED APPLICATIONS

This application claims the benefit of U.S. Provisional Application No. 60/392,998, filed Jun. 28, 2002. It is a continuation-in-part of U.S. application Ser. No. 10/606,566 filed Jun. 26, 2003, the entire specification of which is incorporated hereinto by reference thereto.

### STATEMENT REGARDING GOVERNMENT INTEREST

The United States Government has rights in this invention under DOD/Air Force Contracts: F40600-00-C-0003 (Phase I) and F40600-01-C-0014 (Phase II); and NASA Contract: NAS3-02017 (Phase I).

### BACKGROUND OF THE INVENTION

Combustion instabilities, and other performance deviations, present problems in gas turbine engines, with and without augmentors (afterburners), ramjets, and other combustion-based machines and systems. In combustion-driven systems such as these, interactions between acoustic waves and flame zones may lead to positive feedback in which acoustic waves, generated through unsteady combustion, grow in amplitude by further disturbing the processes that are producing them. In propulsion engines, the onset of combustion instabilities can lead to engine failure and the subsequent loss of the flight vehicle. In the stationary gas turbine industry, combustion instabilities present a considerable obstacle to the development of low-NOₓ gas turbine engines for power generation.

The latest generation of engines utilize lean-premixed combustion to minimize NOₓ production. Lean-premixed operation often results in low-frequency combustion oscillation modes, called “humming.” A gas turbine in a sustained humming mode can suffer severe engine damage due to vibration. When humming sets in on a low-NOₓ, high-firing-temperature, high-mass-flowrate machine, power must be reduced and plant output and revenues are diminished commensurately. In order to realize the full potential of these low-NOₓ engines, therefore, a system must be in place to detect the inception of combustion instabilities, and to initiate, or signal the need for, corrective action before damaging oscillations can develop.

The work of Dowling provides background into instabilities or oscillations during fuel spray combustion (see Dowling, A. P., “Active Control of Combustion Oscillations,” AIAA 99-3571, presented at the 30^{th} AIAA Fluid Dynamics Conference, 28 Jun., 1999, Norfolk, Va.; and Zhu, M., Dowling, A. P., and Bray, K. N. C., “Combustion Oscillations in Burners with Fuel Spray Atomizers,” ASME 99-GT-302, presented at the International Gas Turbine & Aeroengine Congress & Exhibition, Indianapolis, Iowa, Jun. 7-10, 1999). Unwanted unsteady flow occurs frequently, with the resulting pressure oscillations and/or enhanced heat transfer being so intense that structural damage is often done. Such flow instabilities are attributable to interactions between unsteady combustion and acoustic waves. Essentially, unsteady combustion is an effective source of acoustic waves. However, most combustors are highly resonant systems, in which the acoustic waves are reflected from the boundaries to produce flow unsteadiness near the flame, leading to more unsteady combustion. If the phase relationship is suitable, acoustic waves gain energy from their interaction with the combustion. Self-excited oscillations then occur; unsteady combustion generates sound, while the sound waves perturb the combustion.

Significant research has been done to understand conditions that result in combustion instabilities in turbine augmentors and combustors. In addition to Dowling's work, a sampling of references include: Konrad, W., Brehm, N., Kameier, F., Freeman, C., and Day, I. J., “Combustion Instability Investigation on the BR710 Jet Engine,” of Eng. For Gas Turbines and Power, Vol. 120, No. 1, pp. 34-40 (1998); Underwood, F. N., Rusnak, J. P., Ernst, R. C., Petrino, E. A., Russell, P. L., and Murphy, R., “Low Frequency Combustion Instability in Augmentors,” AGARD High Temp. Probl. In Gas Turbine Eng. (Conference paper SEE N78-21118 12-07); and Raghavendra, V., Haran, A., and Samara, B., “Study of Combustion Instability in Gas Turbine Afterburner,” in Proceedings of the 2^{nd} Int. High Energy Materials Conference and Exhibit, Chennai, India, Dec. 8-10, 1998. Techniques involving measurement of acoustic signatures, modification of engine hardware, and advanced modeling, all have been applied in connection with such research. For example, a particular combustor rumble has been found to be due to the design of the fuel injector head, and minor modifications to the spray pattern greatly reduced the combustor noise (see Konrad, W. et al., supra); also an analytical model has been developed to aid in designing augmentors that are free from low frequency instabilities (see Underwood, F. N., et al., supra). Rumble mechanisms investigated include the system airflow dynamics, combustion efficiency oscillations, fuel vaporization, recirculation wake energy, and turbulence upstream of the flameholders. Augmentor screech has been shown to be related to the fuel-air ratio and afterburner inlet pressures (see Raghavendra, V., et al., supra).

A method currently used for controlling potentially devastating combustion instabilities, after they have begun, is to reduce fuel flow. Sound- or pressure-monitors can detect instabilities, but their level of sensitivity precludes using them as early warning and control devices. Their lack of ruggedness also limits their usefulness in the harsh engine exhaust environment.

In U.S. Pat. No. 5,544,478, Shu and Brown disclose that Fourier analysis of ultraviolet emission from a combustion flame yields frequency components that are indicative of gas pressure oscillations. Their invention is used to monitor dynamics within the combustor stage of a gas turbine engine by directly viewing the high-pressure, high-temperature flame region in front of the first-stage or high-pressure turbine. In order to monitor the ultraviolet emission, an ultraviolet-transparent optical window is appropriately mounted within the combustor wall and extends through the combustor flame shield. Specifically, Shu et al. employ a correlation or coincidence of spatial frequency components of the ultraviolet emission from the combustion flame, with dynamic pressure waves characteristic of combustion dynamics, to monitor, control and maintain dynamic pressure vibrations within acceptable limits.

In U.S. Pat. No. 6,271,522, Lindermeir et al. provide a process for the quantitative analysis of gas volumes and, more specifically, random exhaust gases from combustion systems. A spectrometer is used as the measuring instrument, with Fourier spectrometers of the Michelson type being deemed particularly suitable, and a spectrometric measuring set-up, at the exhaust stream of an aircraft engine and employing multiple receive units to span a grid, is described. In the present state of the art, the fastest FTIR spectrometers available are believed to provide capability of a maximum scan speed of 360 scans per second; at the time of the Lindermeir et al. invention, the maximum scan speeds of such spectrometers was perhaps one to two scans per second. Thus, even the contemporary FTIR spectrometers are capable of sampling rates that are at least about an order of magnitude below that which is necessary to recognize the temporal frequencies that are of concern in the present invention.

In AIAA Paper No. 69-580, entitled “Rocket Stability Monitoring by Temporal Radiometry” and presented to the AIAA 5^{th} Propulsion Joint Specialist Conference, Jun. 9-13, 1969, Profitt, R. L., Herget, W. F. and Witherspoon, J. E. describe the use of a remote sensing element for monitoring the time-variation of radiation from exhaust plumes, to detect oscillatory variations in rocket combustion pressures. Frequency analysis of the time-varying radiation, to diagnose combustion instability, is reported to allow stability monitoring of thrust chambers.

Thatcher U.S. Pat. No. 4,342,193 provides a “Convertible Rocket-Air Breathing Engine.” In one mode, the engine is a rocket engine and, in a second mode, it is an air-breathing engine; separate combustion chambers are relied upon for the two different engines.

Also of interest are articles by Docquier and Candel (“Combustion control and sensors: a review,” Progress in Energy and Combustion Science 28 (2002) 107-150), and by Lieuwen and McManus (“That Elusive HUM,” Mechanical Engineering, June 2002, 53-55). The Docquier et al. article suggests that sensors for providing early detection for control of combustor pressure wave problems must be applied at the combustor chamber. It references FTIR in situ measurements in laboratory combustors and also FTIR to analyze aircraft exhaust gases, and states “FTIR systems are too bulky and their time response is too slow for practical applications in combustion control.” Notably, although in-combustor techniques, and both exhaust and in-combustor FTIR techniques, are reported in this state-of-the-art review, exhaust plane measurements to monitor for temporal variations characteristic of dynamic pressure waves or oscillations within the combustor are not suggested. Similarly, although (in the penultimate paragraph) Lieuwen and McManus point to “new diagnostic tools for making pertinent measurements in the unsteady, harsh combustor environment,” there is no suggestion for making measurements at an exhaust plane downstream of a turbine. Clearly, such a technique was not then known by or obvious to those of ordinary skill in the art.

### SUMMARY OF THE INVENTION

It is the broad object of the present invention to provide a sensor arrangement and method for determining instabilities and other system performance deviations that occur, due to combustion instability or a machine malfunction during operation of combustion-based gas turbine systems.

It is a more specific object of the invention to provide such an arrangement and method, and a machine system in which they are incorporated and implemented, wherein and whereby the sensor means detects radiance from an exiting gaseous exhaust stream and requires no intrusion into, or penetration of, the machine casing, wall or shield.

A further object of the invention is to provide an arrangement, system and method having the foregoing features and advantages, which are highly effective for their intended purposes, incomplex, and relatively inexpensive to construct and implement.

In accordance with the invention, it has been found that a simple, rugged, low-cost sensor system can effectively determine incipient and/or existing combustion instability, and provide feedback for combustion or other control. Using an optical sensor for making high-speed measurements of the radiant emission (radiance) from the hot exhaust stream, selected wavelengths of infrared light are employed to capture temporal variations in the radiance. The radiance variations are Fourier analyzed to determine the magnitude and frequency of the combustion instability or other performance deviation. The innovative concept is elegant in that the optical sensor can measure the exhaust flow at the exit of the engine, thus avoiding any requirement for access penetrations into the high-temperature and/or high-pressure regions, as required by, for example, the invention of Shu and Brown. The infrared wavelengths used allow capture of temporal variations in the radiance of the lower temperature engine exhaust; the infrared wavelengths also provide sensitivity to variations in the exhaust flow while being insensitive to potential interference in the ambient environment.

Wavelengths in the infrared spectrum, from 0.78 to 20 microns, are most desirably used, in the practice of the present invention, to measure radiance associated with molecular vibrations and rotations of gas phase species in the hot stream. For turbine engines, the radiance-collecting optical components of the sensor system can be positioned to view the exhaust flow at a location at, or downstream of, the turbine section, including downstream at a position past the nozzle exit; when so positioned, the sensor system does not require physical connection or access penetrations into the engine. For augmentors, the optical components can be positioned to view the exhaust flow downstream of the augmentor fuel injectors, including downstream at a position past the nozzle exit, again avoiding a need for physical connection or access penetrations into the augmentor. From standpoints of convenience and simplicity a “stand-alone” arrangement of sensors is preferred for land-based testing of engines and augmentors, and may advantageously take the form of a mobile, “wheel-up” unit. When located to collect the radiance at or downstream of the turbine section, including downstream of the nozzle exit in the stand-alone configuration, the sensor arrangement enables an indication of dynamics within the turbine engine, including within the compressor, combustor, and turbine sections. Thus, in certain specific embodiments the invention provides a means for determining combustion instability, or a condition of incipient instability or lack thereof, from turbine engines (designed for propulsion, power generation, gas compression, and other uses), and also provides a means for monitoring operational condition.

Most generally, in accordance with the present invention an anomaly (i.e., the presence or absence of a feature, such as a non-random peak in the frequency spectrum) in the radiance signal detected from the exhaust stream of an air-breathing combustion-based machine is used as an indication of system performance deviation, due to combustion instability or machine malfunction. More particularly, however, certain objects of the invention are attained by the provision of an arrangement for monitoring an air-breathing, combustion-based gas turbine machine, comprising optical detector means for detecting radiance of a gaseous exhaust stream exiting from the machine, and for generating a signal representative of the radiance; and frequency recognizing means operatively connected to the radiation detector means for recognizing at least one anomaly in the signal generated by the detector means, as an indicator of existing or incipient machine-performance deviation.

The optical radiation detector means will usually comprise at least one infrared radiation detector, e.g., an indium gallium arsenide device, a mercury cadmium telluride device, a silicon device, or a combination thereof; it will preferably measure infrared light in the wavelength range of 0.78 to 20 microns. The monitoring arrangement will typically employ a spectrum analyzer or electronic data processing means, and the radiation detector means will normally comprise radiation collection optics, a detector head, and a fiber optic for transmitting radiance from the collection optics to the detector head. The radiation detector means employed will usually comprise an array of optical radiation sensors, and in many instances it will most desirably comprise a stand-alone unit mounting the array of sensors.

The temporal variation recognizing means is operatively connected to the optical sensor or detector and is constructed to sample the signal from the detector at a rate of at least 2,000, much more preferably at least 8,000, and most desirably at least 10,000 samples per second, and to determine the intensity and frequency of spectral features in the exhaust stream radiance (such as by a Fast Fourier Transform analysis) so as to thereby enable recognition of at least one anomaly in the detector signal as an indicator of existing or incipient machine performance deviation. The temporal variation recognizing means will usually comprise an amplifier, a digitizer, and a spectrum analyzer or equivalent unit.

Other objects of the invention are attained by the provision of a performance-monitored machine, system, including an air-breathing, combustion-based gas turbine machine and an arrangement for monitoring existing or incipient performance deviation in the machine. The detector means of the system is disposed for optical communication with the exhaust stream exiting from the machine, and it may most advantageously be operatively disposed outwardly adjacent the exit location of the exhaust stream being viewed.

Additional objects of the invention are attained by the provision of a method for monitoring performance deviation in an air-breathing, combustion-based gas turbine machine. In accordance with the method, the radiance of an exhaust stream from the machine being monitored is detected, usually in the infrared spectral region, and a signal representative thereof is analyzed to identify at least one anomaly that is indicative of an existing or incipient machine performance deviation, in turn indicating combustion instability, diminished operating condition, malfunction, and/or needed maintenance.

The apparatus and method of the invention thus utilize a non-intrusive optical measurement for detecting rapid radiance fluctuations, or oscillations, of gas within the exhaust flow of gas turbine engines. Doing so avoids any need for making penetrations into the high-temperature, high-pressure, flame-containing combustor of the machine, in front of the turbine, as taught in the prior art.

It is most surprising that critical optical information can be obtained by the instant method, and is not hindered (or indeed precluded) by the presence of the stationary components and the high-speed moving components of the turbine section in the engine gas path, or by the large temperature-drop and large pressure-drop that occur in the gas during its flow from the combustor to the exhaust; gas temperature and gas pressure decreases of hundreds of degrees and hundreds of pounds-per-square-inch, respectively, occur in the gas during its passage from the combustor section, through the turbine section and to the exhaust section of the machine. Since the condition of the gas is known to change drastically as it impacts, and transfers energy, during its movement through small passages that exist between the dozens of airfoils that are present on both the stationary and also the rotating stages in the turbine section, it has not heretofore occurred to those skilled in the art to take the pertinent measurements from the exhaust; the turbine section would instead be expected to either destroy the oscillatory features that originate upstream, or to so distort them as to preclude detection and/or meaningful analysis. In accordance with the present invention, however, it has unexpectedly been found that meaningful and highly informative rapid fluctuations, or oscillations, are maintained in radiance at detectable levels despite the extreme acceleration, choked flow, and other effects to which the gas is subjected in the turbine section, and that pertinent information is in fact derivable directly from measurements made at the exhaust.

The apparatus and system described herein provide benefits for both the stationary engine industry and also the aeropropulsion engine industry. Such an arrangement would for example be highly useful during the development testing of gas turbine engines and like combustion-based machines, and also as incorporated into systems designed for controlling instabilities. The sensor apparatus and system could additionally be employed for monitoring of overall machine health, power loss, stall, surge, and fuel light-off for such combustion systems.

### BRIEF DESCRIPTION OF THE DRAWINGS

FIG. 1 is a diagrammatic illustration of a laboratory system for modulation of an exhaust flame of selected composition, demonstrating the feasibility of the instant concept;

FIG. 2 comprises three plots of power spectra of the radiance data acquired using the system of FIG. 1 with acoustic excitation of (a) zero (b) 100 Hz and (c) 605 Hz;

FIG. 3 is a diagrammatic illustration of a monitoring arrangement embodying the invention and comprising a stand-alone sensor array unit for providing selective, multi-zone sensing within the area of the exhaust flow exiting a combustion-based machine;

FIG. 4 is an exploded plan view, in partial section, depicting an individual optical receiving head assembly suitable for use in the systems of FIGS. 1 and 3;

FIG. 5 is a plan view, in partial section, depicting an individual detector head assembly suitable for use in the systems of the invention;

FIG. 6 is a plot of detector signal variation of radiance obtained during transition from a nonaugmented to an augmented condition for a running turbine engine;

FIG. 7 comprises two plots of Fourier transform magnitude spectra, setting forth data acquired during two separate time periods for augmented operation of a turbine engine.

FIG. 8 is a plot showing a series of Fourier transform magnitude spectra measured during nonaugmented operation of a turbine engine at various speeds;

FIG. 9 is a schematic representation of a system for detecting performance deviation in a turbine engine having an installed augmentor; and

FIG. 10 is a schematic representation of a conventional gas turbine engine, labeled to identify the sections thereof.

### DETAILED DESCRIPTION OF THE ILLUSTRATED EMBODIMENTS

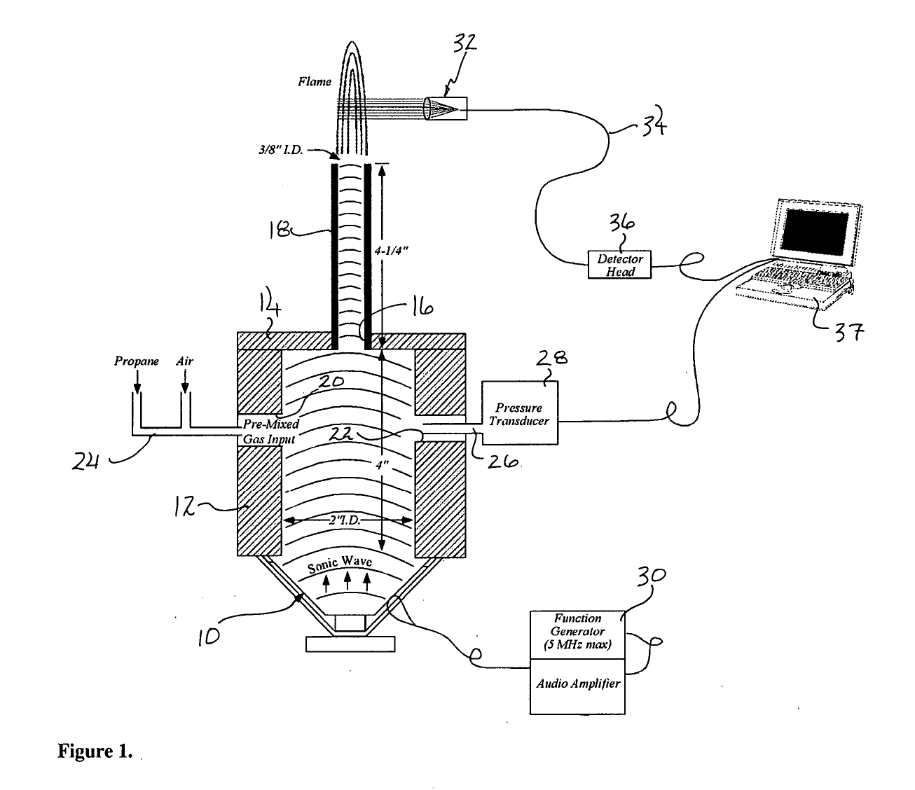

Turning now in detail to FIG. 1 of the drawings, therein illustrated is a simple burner apparatus that was constructed as a laboratory unit to test and demonstrate the concept of the invention. A polypropylene speaker 10 (8 Watt, 4 Ohm, of waterproof design) is sealed to the bottom of a 2″ I.D. aluminum cylinder 12. Sealed to the top of the cylinder 12 is a flat plate 14 having a tapped center hole 16 in which is secured a ⅜″ I.D. steel pipe 18. The aluminum cylinder 12 has tapped holes 20, 22 for a gas input manifold 24 and the conduit 26 of a pressure transducer 28, respectively.

A lean propane/air mixture was fed into the aluminum cylinder 12 to flow out of the steel pipe 18. The speaker 10, with attached amplifier and function generator 30, permits precise pressure oscillations to be imposed upon the gas flow. The pressure transducer 28 (Omega PX213-030A5V) is an absolute gauge (0-30 PSIA) with a 1-millisecond response time, which is fast enough to detect acoustic pressure oscillations at frequencies up to 1000 Hz; at the same time, absolute pressures within the cylinder can be measured.

The simplicity of the sensor is readily appreciated. The collection optic in the optical receiving head, generally designated by the numeral 32, collects radiance from the hot gases produced in the flame at the exit end of the pipe 18 and focuses it onto a fiber optic 34 for energy transmission to the detector head, generally designated by the numeral 36. An electronic data processing unit 37 is operatively connected to the detector head 36 and the pressure transducer 28.

With the receiving head positioned to view the flame, various driving frequencies were imposed upon the gas in the chamber within the cylinder 12, and hence upon the exhaust produced. Table 1 below summarizes the frequencies and the resulting pressure modulations indicated by the transducer; the magnitude of the pressure oscillation was measured in the chamber, and the pressure fluctuation was normalized to the absolute pressure measured (14.847 PSIA):

TABLE 1

| Drive | Pressure | Pressure |
|---|---|---|
| Frequency | Oscillation | Fluctuation |
| (HZ) | (PSID P-P) | (%) |
| 0 | 0.000 | 0.00 |
| 50 | 0.019 | 0.128 |
| 100 | 0.004 | 0.030 |
| 200 | 0.007 | 0.046 |
| 400 | 0.097 | 0.650 |
| 605 | 0.027 | 0.184 |

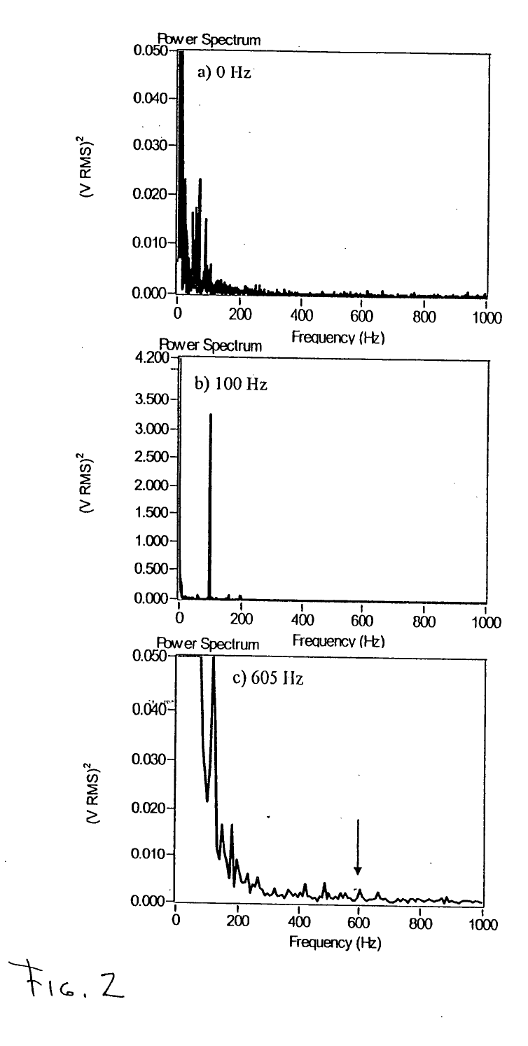

When the speaker was not in operation, the optical sensor was sensitive to natural frequencies of oscillation for the flame. The Fourier transform (power spectrum) of radiance collected with a sampling rate of 10 kHz, and the speaker undriven, is exhibited in FIG. 2a, with a mix of low frequency oscillations apparent. FIGS. 2b and 2c exhibit the power spectra for drive frequencies of 100 Hz and 605 Hz, respectively. It should be noted that the zero Hz and 605 Hz cases are plotted on the same scale (intensity), whereas an increased scale in the power spectrum is used for the 100 Hz case. The applied 100 Hz modulation was much more detectable by the sensor than the 605 Hz modulation, even though the induced lower frequency pressure oscillation was about seven times less in peak-to-peak differential.

There are two possible explanations for this reduced sensitivity. Firstly, and as seen in FIG. 2a (speaker off), the power spectrum contains energy at frequencies up to about 400 Hz. Since this range of frequencies is already present in the flame, acoustic forcing can more easily excite one of these “modes”; higher frequencies have little energy, and so high acoustic frequencies cannot be efficiently coupled into the test flame.

Secondly, the field of view of the sensor was limited to about 0.5 inch for the measurements from the laboratory flame, which was approximately the same diameter. If the spatial period of the oscillation in the flame is less than this field of view, the radiant oscillations will be averaged, thus reducing sensitivity. A video recording of the flame, with a bright raster providing back lighting, revealed that three spatial periods occupy the field of view at 600 Hz, so the sensor will average over those oscillations. This period is dependent upon the frequency of oscillation as well as the velocity of the flow. A higher velocity flow will stretch out the period, improving the sensitivity at higher frequencies. At 100 Hz, the spatial period of the oscillations was about twice the field of view.

Neither of these issues is a factor in the actual on-engine measurements, described below. Since, for example, rumble and screech are caused by a coupling of the combustion instabilities to the natural frequencies of the engine and components, the first effect does not exist. The second issue is also not a factor because the velocity of the engine exhaust is significantly higher than is the exit velocity of the lab flame, which is believed to prevent multiple spatial periods from overlapping the sensor field of view.

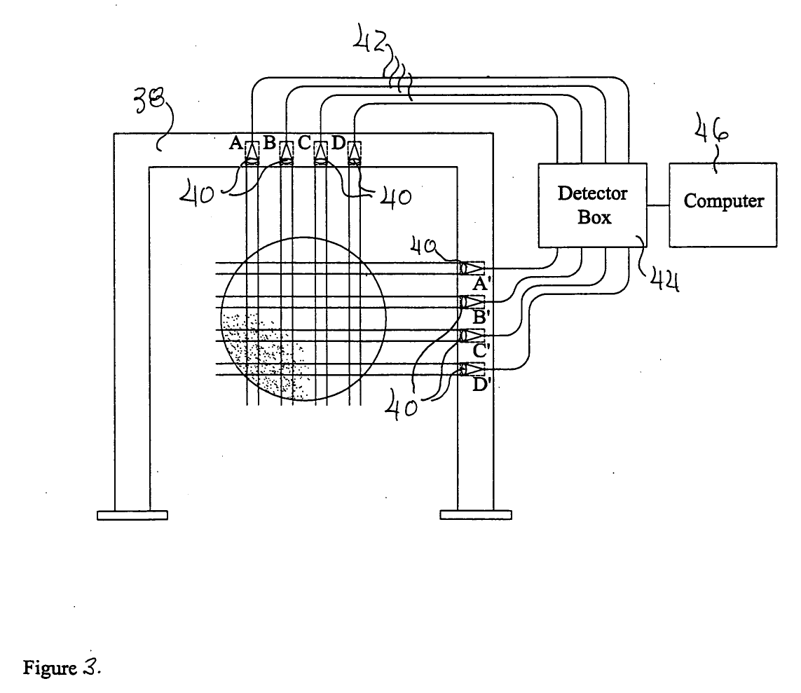

The sensor arrangement of FIG. 3, embodying the present invention, comprises an array of receiving heads 32 mounted upon a mobile, stand-alone frame 38 for observing an exhaust plume (the view of the Figure looking into the exit end of a nozzle), the simplicity of which arrangement is readily appreciated. More particularly, the collection optic in each optical receiving head 32 (individually designated A, B, C, D, A′, B′, C′, D′) collects radiance emitted from the flow of hot gases G (arbitrarily bounded by a circle, but alternatively being rectangular or of another shape) and focuses it into a fiber optic 34 for energy transmission to a detector in the detector box 44, to which an electronic data processing unit 46 is operatively connected.

Indicators of performance deviation (e.g., instability) need be present only in part of the exhaust plume to be observed with the sensor array. For example, if the indicator is present in the lower left (shaded) flow region, the indicator signal will be observed from detectors that are linked by the fiber optics 34 to those of the optical receiving heads 32 that are labeled A, B, C′ and D′. A perpendicular array geometry, affording an intersecting grid of sight lines, is effective and convenient to install for round or rectangular nozzles, even those that adjust the nozzle opening to thrust levels. This embodiment of the invention is not of course limited to such an arrangement, or to the four-by-four array of sensor heads depicted; a greater number of sensor heads, or indeed a single sensor head, may be implemented beneficially, as may a non-perpendicular formation of multiple sensor heads.

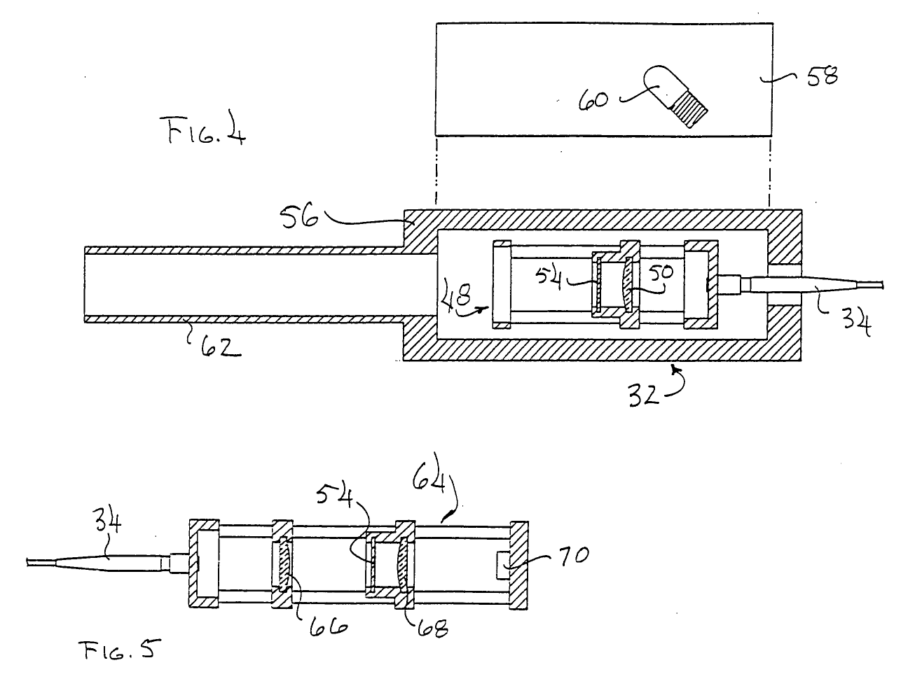

FIG. 4 is a plan view, in partial section, of an individual optical receiving head 32 suitable for use in the systems of FIGS. 1 and 3. The receiving head 32 employs an optical mount structure, generally designated by the numeral 48, which is of stock rod and plate construction; it mounts a lens 50 for focusing the collected radiance onto the fiber optic 34, as well as an optical filter 54. The mount structure 48 is encased in an aluminum box 56, having a removable cover 58 (shown in exploded relationship to the box) with a connector 60 for supplying a clean gas purge into the box 56, which exits the box through the tube 62; the gas purge prevents ambient airborne particles and aerosols from contacting the optical components, as would tend to degrade performance. The tube 62 defines the optical path through which radiance from the hot gas flow is received. It will be appreciated that a suitable receiving head can also be fabricated by replacement of the lens 50 with a focusing mirror for collecting the hot gas radiance and condensing it onto the fiber optic 34.

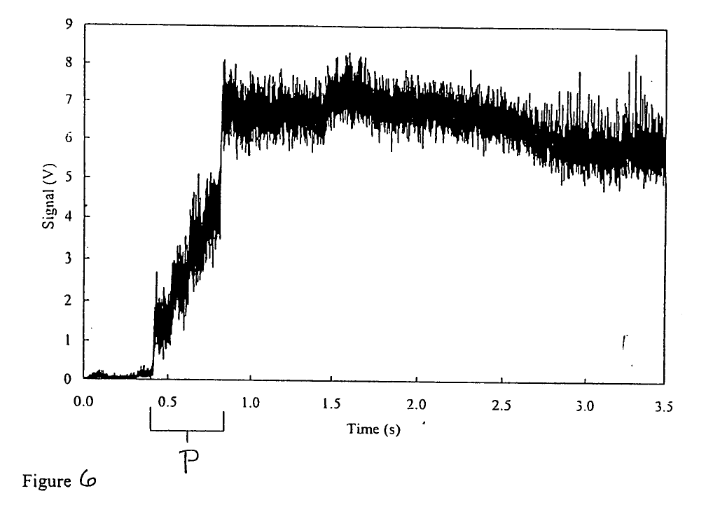

As seen in FIG. 5, the detector head employs a similarly constructed optical mount structure, generally designated by the numeral 64, which supports a first lens 66 and a second lens 68, as well as an optical filter 54. The first lens 66 receives and collimates the transmitted radiance exiting the fiber optic 34, the collimated radiation being received and condensed onto the detector 70 by the second lens 68, after passing through the filter 54. As will be appreciated, a filter will not usually be employed in both the receiving head and also the detector head, and in many instances no optical filter at all will be required. A suitable detector head can of course be fabricated by replacing the lenses with mirrors, or by close coupling of the fiber optic to the detector without intermediate optical components if the detector is of suitable type.

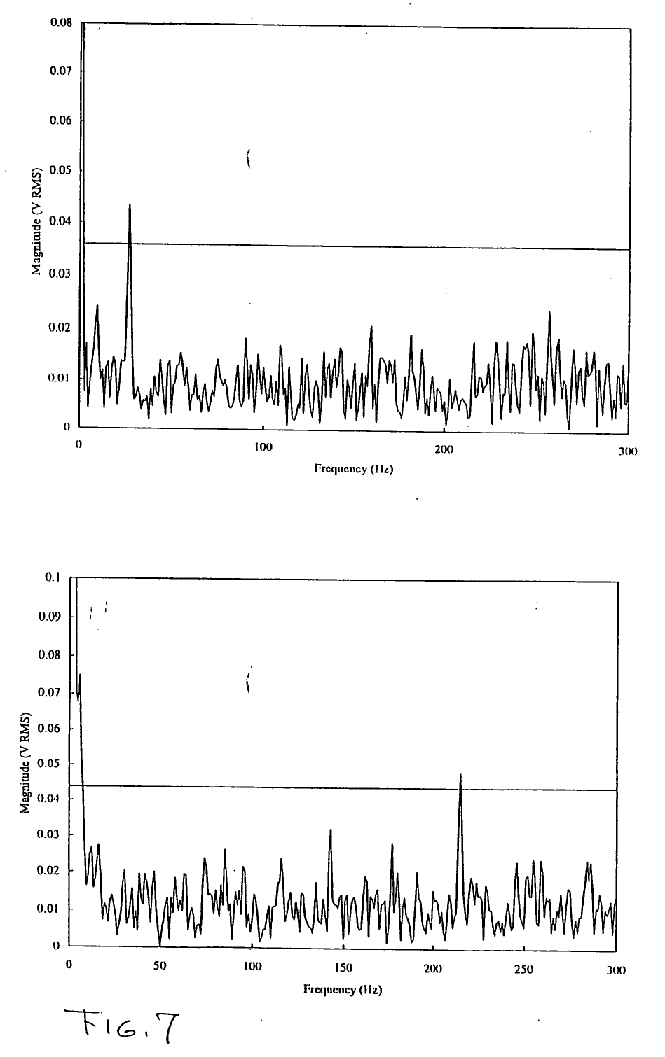

FIG. 6 represents radiance data collected, during a 3.5 second time span, with an optical receiving head and transferred to a detector head, in a system such as that of FIGS. 3, 4 and 5, and including a transition from nonaugmented to augmented condition for a running turbine engine. The stepped increase in the radiance level, over the approximately 0.5 second period P during which the augmentor fuel injectors were turned on, should be noted in particular. It will be appreciated that, as so employed, the arrangement described also serves as a sensor for augmentor light-on and light-off for fuel injectors.

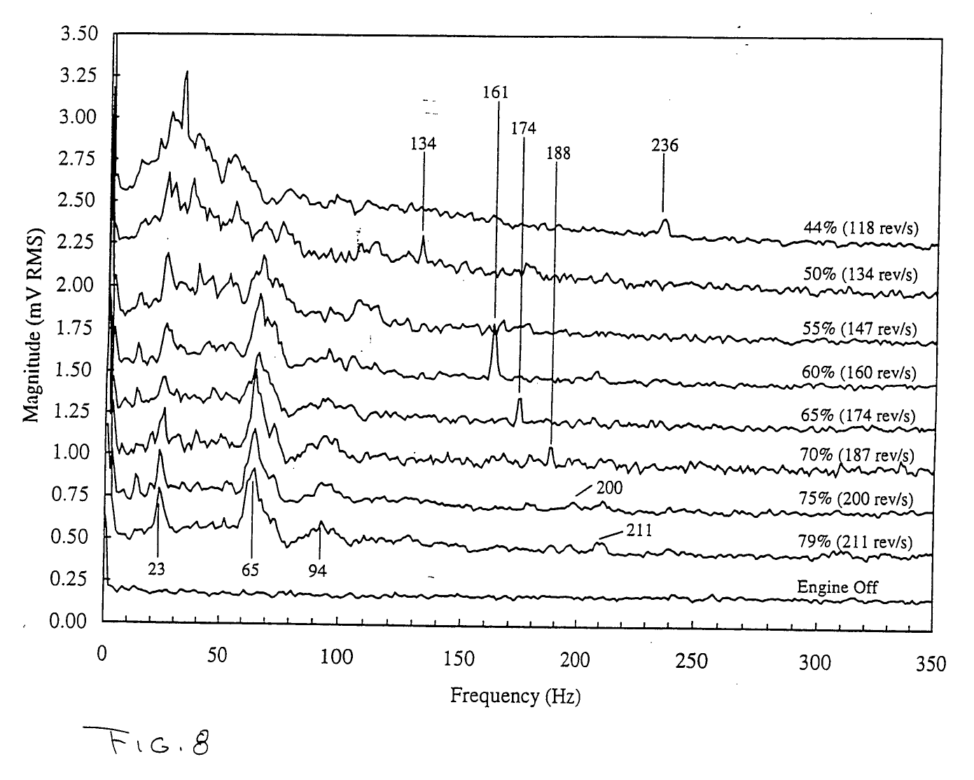

FIG. 7 presents two frequency spectra (fast Fourier transform intensity plotted against frequency) processed from data acquired during two segments of augmentor operation, monitored as hereinabove described. FIG. 7a displays a nonrandom peak at 27 Hz; FIG. 7b displays a non-random peak at 215 Hz. The data processing routine, performed by computer 46, considers a peak to be non-random if it is above a threshold level based on the 90^{th} percentile for frequencies in the pass band. The lower frequency oscillation was not always present in the optical data obtained during this particular operational setting of the augmentor, thus indicating a transient condition in the hot flow from the augmentor. The higher frequency oscillation at 215 Hz in FIG. 7b was recorded during augmentor operation when the revolution rate of the high-pressure turbine was at a comparable frequency. It may therefore be concluded that the detected radiance fluctuations originated upstream of the augmentor, at a location in the high-pressure compressor, combustor, or turbine sections of the engine (without optical intrusion into those sections).

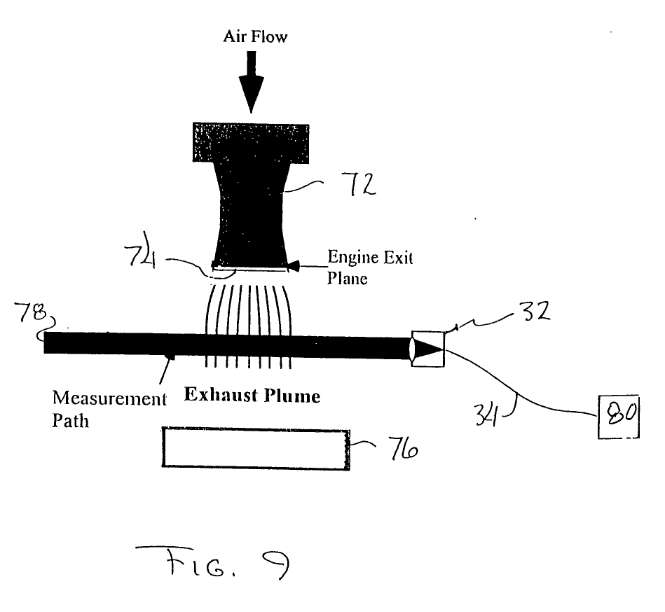

FIG. 8 presents a series of frequency spectra measured for incremental steps in an engine speed setting, the spectra being offset from one another in the plot to improve the presentation. The engine-off condition is at the bottom; the incremental engine power settings, from 44% to 79% (percent of full speed), and the engine rotational speed for that setting based on the tachometer reading, are labeled.

Important features, relevant to the detection of engine anomalies, including power (thrust) loss, are reflected in FIG. 8; the appearance of two different types of features is immediately noted. Firstly, at low frequencies many peaks appear over the broad range of engine speeds. Some of the peaks, such as those designated at frequencies 23, 65 and 94 Hz, are of generally fixed frequency with engine power. However, the magnitude and shape of the complete range of low frequency peaks between 10 and 120 Hz varies with engine power. Even at the 5% power-change intervals performed here the low-frequency signatures are observably different.

Thus, it is seen that frequencies in the 35-55 Hz range become higher in magnitude at the lower power settings, and that the 94-Hz feature of 79% power drifts to slightly higher frequency as engine power is reduced. The 65-Hz feature loses intensity toward lower power. Clearly, the observations are not just related to the general magnitude of gas temperature, since some frequencies increase in magnitude at the lower gas temperature (higher engine power) conditions. Those frequencies are in the range typically associated with rumble or humming (combustion instability) in gas turbine engines. However, the structure of the frequency spectrum below 100 Hz was found to give a good indication of the engine speed.

The second significant feature of the power signatures depicted in FIG. 8 resides in the frequency components that track engine rotational speed. The frequency peaks are labeled, and can be compared to the tachometer readings at the right side of the Figure. At most power settings, one engine revolution yields one radiance cycle.

The exceptions in this case are at the 55% power setting, which does not present a characteristic power frequency, and the 44% power setting (engine idle) which does present a characteristic frequency but at exactly two radiance cycles for one engine revolution. The presence of frequency components that track turbine engine rotational speed provide, in accordance with the present invention, a novel means for monitoring engine health and power loss conditions. The presence of the speed-tracking peaks make it possible to detect when the engine power (thrust) wavered, even by less than one-half Hz, thus demonstrating the ability of the instant sensor arrangement to monitor the onset of thrust loss due, for example, to mechanical events that occur in the engine, or fuel supply loss.

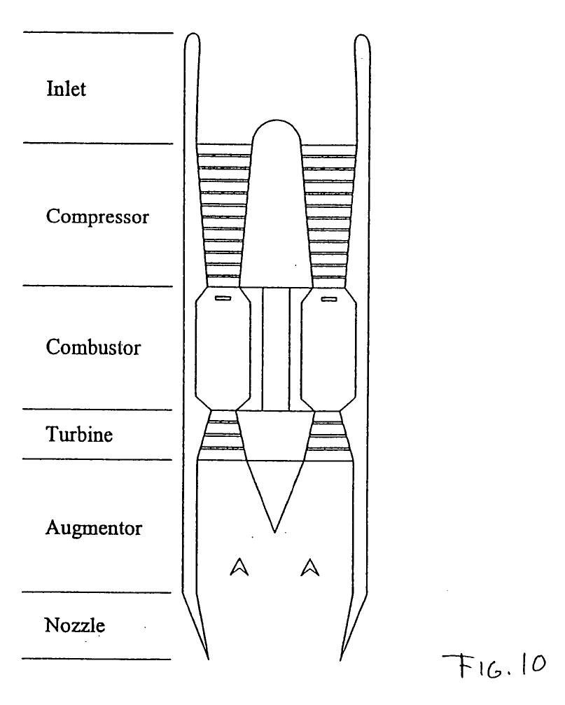

As depicted in FIG. 9, a sensor arrangement embodying the invention can, for example, be installed on, or in association with, a turbine engine 72 fitted with an augmentor 74 in a propulsion development test cell, with measurements being made along a sight line at the nozzle exit plane, in the available space between the nozzle and diffuser 76. Such an arrangement may comprise the arrangement of FIG. 3, and may employ the receiving and detector heads described, respectively, in FIGS. 4 and 5. As noted above, the temporal variation recognizing means 80, to which the detectors employed in the arrangement are operatively connected, will usually comprise an amplifier, a digitizer (A:D converter) and a computer or other form of frequency analyzer.

In further regard to the sensor arrangement and the temporal variation recognition means, it will be appreciated that, in detecting oscillations or other temporal anomalies during the operation of gas-turbine engines, the detector, amplifier electronics, and digitizer system must be chosen to capture, and permit discrimination of, events that occur rapidly in time and that consequently produce radiance levels that also vary rapidly in time; significant attenuation of the detector signal must also be avoided. For example, due to engine geometry and gas path temperatures, a particular engine might exhibit combustion instability with frequencies up to 4000 Hz. The radiance detector employed must therefore be chosen so that it can respond to fluctuations of this frequency as it converts the incident radiance to an electrical signal. That is, the impulse response of the detector must be narrow enough in time that it does not smear out features in the incident radiance. In the frequency domain, this means that the complex Fourier transform of the impulse response, as a function of frequency, should be of nearly constant magnitude and nearly zero phase at the frequencies of interest (e.g., from 0 to 4000 Hz). Similarly, the amplifier electronics, the response of which can be described by a convolution integral, should also exhibit nearly constant magnitude and nearly zero phase over the frequency range of interest.

The digitizer must be capable of digitizing the output signal from the amplifier electronics at a frequency of at least twice the highest frequency of interest (preferably, at a rate of at least 8000 samples per second, to accommodate an instability frequency as high as about 4000). Because components of the signal with frequencies higher than half the sampling rate will be aliased down to lower frequencies, it may be necessary or desirable to incorporate an anti-aliasing filter into the amplifier electronics, making the frequency response of the electronics of nearly constant magnitude and nearly zero phase over the frequencies of interest, and rapidly approaching zero magnitude for frequencies above that range.

In the specific application described, it is seen that a select infrared wavelength region can be used to detect incipient rumble and screech in a turbine engine fitted with an augmentor. It is also seen that the system is capable of detecting the discrete changes in plume intensity that are associated with ignition of each of the injectors when the engine was snapped to augmented mode, as well as low-level rumble. During nonaugmented operation, the data obtained may be indicative of frequencies that are typically present during normal engine operation; monitoring and characterizing those frequencies provides a means for determining when an engine is running abnormally. In addition to being able to detect the onset of screech and rumble, therefore, the system described may also afford further benefits when mounted in, or adjacent to, a test cell, a turbine engine (propulsion or stationary), or the like; e.g., using multiple sensors the cause of combustion instabilities may be located, low-cost engine health monitoring is enabled (such as to provide an early warning that preventative maintenance should be scheduled), and stall onset, surge, power loss, and augmentor light-off detection may be afforded.

Many variations in the described apparatus can of course be made within the scope of the invention, as will be appreciated by those skilled in the art. For example, the receiving head may employ an off-axis parabolic mirror in place of the simple lens depicted, so as to enable the head to lie tight against a test cell wall. It will also be appreciated that multiple detector heads, having different response properties, can be used simultaneously. Also, two IR detectors of different wavelength response, either inherently or by optical filtering, may be provided. Indeed sensors that respond in the ultraviolet and/or visible regions may be employed, alone or in combination with infrared detectors, in appropriate circumstances. For monitoring the ambient forces subjected onto the receiving heads in the engine proximity, a pressure-sensitive detector (microphone) and/or directional accelerometers may also be mounted on the receiving head. Although the temporal variation recognizing means will usually comprise a spectrum analyzer or a suitably programmed computer, the invention may be implemented using an oscilloscope in appropriate circumstances.

In a propulsion development test cell the fiber optic of the optical head may pass through the cell wall to transmit the exhaust plume intensity to the detector heads. In the case of a turbine engine used for electric power generation, gas compression, or other function, the optical head can be mounted to the exhaust duct that collects the exhaust gas from the engine exit. As is seen in FIG. 9, the optical head 32 will advantageously be targeted at the exit plane of the engine 72, in the available space between it and the exhaust gas diffuser 76, with measurements of radiant intensity being collected from a transverse line-of-sight 78 across the plume.

It might be mentioned that, in some instances, it has been noted that the radiance from the exhaust stream is characterized by high-energy bursts (“pops”). That condition can be accommodated in the practice of the invention by detecting and generating a separate signal representative of the energy bursts by appropriate optical or electronic filtering, and subtracting that signal from the composite signal.

Thus, it can be seen that the present invention provides a sensor arrangement and method for monitoring performance deviations that occur, due to combustion instability or a machine malfunction, during operation of air-breathing, combustion-based gas turbine machines. The sensor means detects radiance from an exiting gaseous exhaust stream, and requires no intrusion into, or penetration of, the machine casing, shield, or the like. The arrangement, system and method of the invention are highly effective for their intended purposes, and are incomplex and relatively inexpensive to construct and implement.

While only certain preferred features of the invention have been illustrated and described herein, many modifications and changes will occur to those skilled in the art. It is therefore to be understood that the appended claims are intended to cover all such modifications and changes as fall within the true spirit of the invention.

Having thus described the invention, what is claimed is:

1. An arrangement for monitoring existing or incipient performance deviation in an air-breathing, combustion-based gas turbine machine, comprising:
optical radiation detector means for detecting, in a selected wavelength range, radiance of a gaseous exhaust stream exiting from an air-breathing combustion-based gas turbine machine, and for generating a signal representative of the radiance; and
temporal variation recognizing means, operatively connected to said radiation detector means, for sampling said signal from said radiation detector means at a rate of at least 2,000 samples per second, and for determining the intensity and frequency of spectral features in the exhaust stream radiance, so as to thereby enable recognition of at least one anomaly in the signal generated by said detector means as an indicator of existing or incipient machine performance deviation.

2. The arrangement of claim 1 wherein said optical radiation detector means comprises at least one infrared radiation detector.

3. The arrangement of claim 2 wherein said at least one radiation detector comprises a photosensitive device selected from the group consisting of indium gallium arsenide photosensitive devices, mercury cadmium telluride photosensitive devices, silicon photosensitive devices, and combinations thereof.

4. The arrangement of claim 2 wherein said optical radiation detector means measures infrared light in the wavelength range of 0.78 to 20 microns.

5. The arrangement of claim 1 wherein said temporal variation recognizing means comprises a spectrum analyzer.

6. The arrangement of claim 1 wherein said temporal variation recognizing means comprises electronic data processing means.

7. The arrangement of claim 1 wherein said radiation detector means comprises radiation collection optics, a detector, and a fiber optic for transmitting radiance from said collection optics to said detector.

8. The arrangement of claim 1 wherein said radiation detector means comprises an array of optical radiation sensors.

9. The arrangement of claim 8 wherein said radiation detector means comprises a stand-alone unit mounting said array of sensors.

10. A performance-monitored machine system including an air-breathing, combustion-based gas turbine machine in which a gaseous exhaust stream is produced; and an arrangement for monitoring existing or incipient performance deviation in said machine, said arrangement comprising:
optical radiation detector means, for detecting, in a selected wavelength range, radiance of a gaseous exhaust stream exiting from said machine and for generating a signal representative of the detected radiance, said detector means being operatively disposed for optical communication with the exhaust stream; and
temporal variation recognizing means, operatively connected to said radiation detector means, for sampling said signal from said radiation detector means at a rate of at least 2,000 samples per second, and for determining the intensity and frequency of spectral features in the exhaust stream radiance, so as to thereby enable recognition of at least one anomaly in the signal generated by said detector means as an indicator of existing or incipient performance deviation in said machine.

11. The machine system of claim 10 wherein said gas turbine machine is comprised of compressor, combustor, and turbine sections, said temporal variation recognizing means functioning to permit recognition of said anomaly in at least one of said sections.

12. The machine system of claim 10 wherein said gas turbine machine additionally includes an augmentor, and wherein said temporal variation recognizing means functions to recognize said anomaly in said augmentor.

13. The machine system of claim 10 wherein said temporal variation recognizing means comprises a spectrum analyzer.

14. The machine system of claim 10 wherein said temporal variation recognizing means comprises electronic data processing means.

15. The machine system of claim 10 wherein said radiation detector means comprises an array of optical radiation sensors.

16. The machine system of claim 15 wherein said array of sensors is operatively disposed adjacent the exit location of the exhaust stream, outwardly of said gas turbine machine.

17. The machine system of claim 15 wherein said optical radiation detector means comprises a stand-alone unit.

18. The machine system of claim 10 wherein said optical radiation detector means comprises at least one infrared radiation detector.

19. The machine system of claim 18 wherein said optical radiation detector means measures infrared light in the wavelength range of 0.78 to 20 microns.

20. A method for monitoring existing or incipient performance deviation in an air-breathing, combustion-based gas turbine machine having a gaseous exhaust stream produced thereby and exiting therefrom, comprising:
detecting radiance of said exhaust stream, in a selected wavelength range, and generating a signal representative of said exhaust stream radiance; and
analyzing the temporal variation of said representative signal to identify at least one anomaly therein that is indicative of existing or incipient machine performance deviation.

21. The method of claim 20 wherein said at least one anomaly is a non-random peak in the temporal frequency spectrum.

22. The method of claim 20 wherein the step of detecting radiance comprises detecting infrared radiation emitted by said exhaust stream.

23. The method of claim 20 wherein said combustion-based gas turbine machine additionally includes an augmentor, and wherein the exhaust therefrom, at a location downstream of the injectors thereof, constitutes the exhaust stream from which radiance is detected.

24. The method of claim 20 wherein said performance deviation indicated by said anomaly in said representative signal is indicative of at least one of: existing or incipient combustion instability, diminished operating condition, malfunction, and needed maintenance.

25. The arrangement of claim 2 wherein said optical radiation detector means additionally comprises an optical filter for limiting the wavelength range of radiance incident on said radiation detector.

26. The machine system of claim 18 wherein said optical radiation detector means additionally comprises an optical filter for limiting the wavelength range of radiance incident on said radiation detector.
